(19) United States
(12) Patent Application Publication
(10) Pub. No.: US 2025/0044565 A1
(43) Pub. Date: Feb. 6, 2025

(54) OPTICAL ELEMENT

(71) Applicant: AMS SENSORS ASIA PTE. LTD., Singapore (SG)

(72) Inventor: Chen LI, Richterswil (CH)

(21) Appl. No.: 18/719,869

(22) PCT Filed: Dec. 16, 2022
(86) PCT No.: PCT/SG2022/050913

§ 371 Date: Jun. 14, 2024

(30) Foreign Application Priority Data
Dec. 16, 2021 (GB) 2118252.2

(51) Int. Cl. G02B 19/00

(52) U.S. Cl. CPC G02B 19/0057; G02B 19/0028

(57) ABSTRACT

An optical element for beam-shaping applications is disclosed. The disclosed optical element includes a plurality of structures formed on a substrate, wherein in a cross-section orthogonal to a plane defined by the substrate, an upper portion of a surface of each structure has a greater tilt-angle relative to an optical axis orthogonal to the substrate than a lower portion of the surface, the lower portion being closer to the substrate than the upper portion. Each structure may be arranged on the substrate such that radiation entering each structure through the substrate, in a direction substantially parallel to the optical axis and undergoing internal reflection within each structure, exits the surface of each structure along a path that does not intersect a directly adjacent structure of the plurality of structures.

### CROSS-REFERENCE TO RELATED APPLICATIONS

This application is a 371 U.S. National Phase of PCT International Patent Application No. PCT/SG2022/050913, filed on Dec. 16, 2022, which claims priority from GB Patent Application No. 2118252.2, filed on Dec. 16, 2021, the disclosures of which are incorporated by reference herein in their entirety for all purposes.

### TECHNICAL FIELD OF THE DISCLOSURE

The present disclosure is in the field of optical elements for beam-shaping applications. The disclosure relates in particular to optical elements configured to shape a beam of radiation to provide a relatively wide field of illumination.

### BACKGROUND

Beam-shaping may be required in a variety of applications. For example, in applications requiring a particular field of illumination, beam-shaping may be employed to direct radiation from a source to be incident upon a scene as a field exhibiting a desired shape and/or intensity distribution.

In an example, an infrared flood illuminator may be used for time-of-flight measurements, wherein the flood illuminator is configured to shape a beam of infrared radiation from a source to provide a uniformly distributed field of illumination upon a target scene.

In other examples, such as vehicle in-cabin monitoring or driver monitoring, a particular non-uniform shape of a field of illumination and/or intensity pattern may be required to enable effective monitoring of an interior space within the vehicle. That is, a non-circular angular light distribution pattern and/or rotationally asymmetrical light intensity distribution may be required.

Known beam-shaping solutions may include optical elements such as lenses to direct radiation as required.

Furthermore, in some applications, a wide field of illumination may be required. Achieving a wide field of illumination may require a complex system of lenses, or other optical components.

Existing beam-shaping solutions using micro-optical device such as micro-lens arrays may be unable to efficiently direct radiation over a wide field of illumination. For example, existing micro-optical beam-shaping solutions may exhibit substantial Fresnel losses due to large refraction angle and a “shadowing” effect, wherein radiation from a micro-structure is partially blocked by a neighboring micro-structure before reaching a target.

Optical elements for efficiently providing a sufficiently wide field of illumination may require complex optical structures, which may be both expensive and technically challenging to manufacture.

It is therefore desirable to provide a beam-shaping solution that is configurable to provide a beam of radiation having a desired shape and/or intensity distribution, and in particular suitable for providing a beam of radiation having a wide field of illumination. It is also desirable that such a beam-shaping solution is of high optical efficiency, low-complexity, and generally suitable for manufacture using commercially available manufacturing equipment and techniques.

It is therefore an aim of at least one embodiment of at least one aspect of the present disclosure to obviate or at least mitigate at least one of the above identified shortcomings of the prior art.

U.S. Pat. No. 9,946,055 B2 (Krijn et al.) describes a beam-shaping system for use over an array of light sources.

U.S. Pat. No. 7,548,376 B2 (Kim et al.) describes a total internal reflection micro lens array for a wide-angle lighting system.

### SUMMARY

The present disclosure is in the field of optical elements for beam-shaping applications. The disclosure relates in particular to optical elements configured to shape a beam of radiation to provide a relatively wide field of illumination.

According to a first aspect of the disclosure, there is provided an optical element including a plurality of structures formed on a substrate, wherein in a cross-section orthogonal to a plane defined by the substrate, an upper portion of a surface of each structure includes a greater tilt-angle relative to an optical axis orthogonal to the substrate than a lower portion of the surface, the lower portion being closer to the substrate than the upper portion.

Each structure may be arranged on the substrate such that radiation entering each structure through the substrate, in a direction substantially parallel to the optical axis and undergoing internal reflection within each structure, exits the surface of each structure along a path that does not intersect a directly adjacent structure of the plurality of structures.

Advantageously, the disclosed structure may enable a highly efficient transmission of radiation over a large field of illumination, e.g. with a wide-angle of illumination. For example, embodiments of the disclosure may generate a field of illumination spanning in the region of 165 degrees full angle about the optical axis, with a transmission efficiency higher than 90%. That is, because the structures are configured and arranged such that the radiation entering each structure through the substrate exits the surface of each structure along a path that does not apply strong refraction and does not intersect a directly adjacent structure of the plurality of structures, any Fresnel losses are relatively low, any “shadowing” effects are avoided and therefore an overall optical transmission efficiency may be relatively high.

Advantageously, the disclosed structure may enable manufacture of a relatively low-profile optical element. That is, a maximum height of the structures, e.g. maximum distance to which the structures protrude from the substrate, may be relatively low over an entire area of the substrate, thereby simplifying manufacture of the optical element.

Advantageously, because the radiation exits the surface of each structure along a path that does not intersect a directly adjacent structure of the plurality of structures, and generally exits the upper portion of the surface of each structure, the structures may be densely populated on the substrate, e.g. covering an entire optical surface of the substrate. As such, an efficiency of the optical element at shaping a beam of radiation may be relatively high, because structures densely packed over the entire optical area of the optical element may contribute to the beam-shaping, and radiation does not propagate through substantial gaps between the structures.

The term “directly” adjacent will be understood to refer to a neighboring structure, e.g. an immediately adjacent structure

The directly adjacent structure may be a nearest neighboring structure.

The term “surface” of the structure will be understood to refer to a peripheral surface, e.g. an outwardly facing lateral surface, of the structure.

The term “optical surface area” will be understood to refer to a surface area of the substrate through which the radiation propagates.

The term “internal reflection within each structure” may refer to a Total Internal Reflection (TIR) within each structure, e.g. a reflection off an internal surface of the structure when an angle of incidence is greater than a critical angle.

The plurality of structures may include one or more structures formed as a closed loop, ellipse, oval, ring, or continuous free-form shape in a cross-section parallel to the plane.

Advantageously, formation of such shapes, in particular closed loop shapes, provides a highly efficient means to cover the entire optical surface area of the substrate.

Advantageously, formation of such shapes, in particular closed loop shapes, enable radiation to be directed all around the optical element. Furthermore, selection of the shape enables selection of a particular intensity distribution, as described in more detail below with reference to the drawings.

A height of the one or more structures may vary along at least a portion of the one or more structures. A width of a base of the one or more structures may vary along at least a portion of the one or more structures.

That is, the height of the one or more structures and/or the width of the base of the one or more structures may be non-constant over a length of the one or more structures.

Advantageously, structures for an optical element may be designed to exhibit such variations in height and/or width, thereby effectively tuning the design of an optical element to provide a desired shape and/or intensity distribution of a field of illumination. As an example, a constant height and width may be used to implement an optical element for use in a flood illuminator to provide a uniform field of illumination. A varying height and/or width may be used to implement an optical element for use in an illuminator to provide a non-uniform field of illumination having an intensity distribution with one or more peaks.

For purposes of illustration, a polar angular coordinates system may be applied to the field of illumination, wherein the polar (0° polar angle) is perpendicular to the substrate.

In an example, the closed loop shape of the structures may be modified to control a total light power, e.g. an accumulated power in polar angle range from 0° to 90°, towards various pairs of Azimuth direction from >=0° &180° to <180° &360°. That is, the total power radiating in a plane, which has the polar and various Azimuth vector in it, may be defied by design of the closed loop shape of the structures.

In an example, a cross-sectional shape (including height and base width) of the structures may be modified to control a light power distribution towards various polar angle in a given pair of Azimuth direction.

When the cross-section is asymmetrical, the distributions to each Azimuth direction of a pair are not identical, i.e. the light power distribution, radiating in a plane with the polar in it, is asymmetrical, as described in more detail below.

Each structure of the plurality of structures may be disposed beside another structure of the plurality of structures such that there are no gaps between the structures.

Advantageously, an optical efficiency of the optical element may be increased by ensuring no gaps exist between the structures. That is, by providing no gaps between structures, substantially all of the radiation propagating thought the substrate may be directed through the structures which are configured to redirect the radiation by total internal reflection.

A height of each structure of the plurality of structures may be substantially the same as a height of an adjacent structure of the plurality of structures.

Advantageously, a height may be substantially uniform in any direction in a plane parallel to the substrate, which may simplify a manufacturing process and improve a robustness of the optical element.

That is, due to a shape of the disclosed structures, even with the height of each structure being substantially the same in a direction in a plane parallel to the substrate, little or no shadowing may occur, thus maximising an optical efficiency of the optical element.

The term “shadowing” will be understood to refer to an effect wherein radiation from a structure is at least partially blocked by a neighboring structure.

At least one structure of the plurality of structures may be rotationally symmetrical about an axis parallel to the optical axis.

Advantageously, such a structure may be suitable for providing for uniform flood illumination.

The plurality of structures may be arranged concentrically on the substrate.

Advantageously, a concentric arrangement of structure provides a highly efficient means to cover a large surface area of a substrate without substantial gaps between structures.

Furthermore, in some embodiments, the concentrically arranged structures may have substantially the same cross-section. As such, each structure may be configured to generate substantial the same field of illumination as each other concentrically arranged structure.

The optical element may including a microlens array disposed at a center of the concentrically arranged plurality of structures.

The microlens array may be configured to fill an area inside a concentric arrangement of structures, such that radiation propagating though the through the center of the concentrically arranged plurality of structures also propagates through the microlens array.

Advantageously, in some embodiments the microlens array may be configured to redirect the radiation to provide field of illumination that is continuous with the field of illumination provided by the plurality of structures.

In embodiments, the microlens array may be suitable for directing radiation with a relatively low angle relative to the optical axis, e.g. up to 20 or 30 degrees, whereas the above-described structures may be suitable for directing radiation with a greater angles, e.g. more than 20 or 30 degrees.

The optical element may include a substantially conical structure disposed at a center of the concentrically arranged plurality of structures.

A surface of the conical structure may have, in a cross-section orthogonal to the plane defined by the substrate, an upper portion including a greater tilt-angle relative to the optical axis than a lower portion, the lower portion being closer to the substrate than the upper portion. The conical structure may be arranged on the substrate such that radiation entering the conical structure through the substrate, in a direction substantially parallel to the optical axis and undergoing total internal reflection within the conical structure, exits the surface of the conical structure along a path that does not intersect a directly adjacent structure of the plurality of structures.

Advantageously, the conical structure may enable substantially all of the optical surface of the substrate to be covered with structures having a similar cross-section, such that all structures including the central conical structure may contribute to a substantially same field of illumination.

A peak of the one or more structures of the plurality of structures may be rounded.

Advantageously, a rounded peak may enable some radiation to propagate directly through the conical structure, in a direction substantially parallel to the optical axis, thus avoiding any gap within the field of illumination provided by the optical element.

In some examples, a base of the one or more structures of the plurality of structures may be rounded, e.g. curved in a region close to the substrate. In some examples, a trough between structures of the plurality of structures may be rounded. That is, in such embodiments the plurality of structures do not meet at sharp angles at the substrate, but instead meet at a curved portion.

The surface of each structure may be segmented. One or more segments in the upper portion may have a tilt-angle greater than one or more segments in the lower portion, e.g. greater than one or more tilt angles of the one or more segments in the lower portion.

Advantageously, a process of design and manufacture of the optical element may be simplified by designing forming each structure form a plurality of segments. Furthermore, simulation of the performance of the optical element may be simplified by use of a segmented structure.

In other embodiments, the surface of each structure may be smooth, e.g. designed in a freeform manner, to minimize sharp angles provide a field of illumination as a continuum rather than with distinct or discrete and/or separate fields of illumination.

Each structure may be configured as a prism including a plurality of surfaces for reflecting and refracting the radiation entering each structure through the substrate.

That is, each structure may be formed from one or more planar or flat surfaces, such as segmented surfaces.

The path may be at an angle of greater than 70 degrees relative to the optical axis.

Advantageously, the disclosed structures enable generation of a field of illumination spanning a large full angle about the optical axis.

In embodiments, the path may be at an angle of greater than 70 degrees relative to the optical axis, e.g. a full angle of 140 degrees. In some embodiments, the path may be at an angle of greater than 80 degrees or more relative to the optical axis.

The optical element may be provided in combination with a radiation source, wherein the radiation source may be configured to emit radiation towards the substrate such that the radiation enters each structure through the substrate in a direction substantially parallel to the optical axis.

In embodiments, the radiation sauce may include one or more lasers and/or other sources of coherent and/or directional radiation configured to direct radiation towards the substrate in a direction generally parallel to the optical axis.

While the radiation emitted towards the substrate may be substantially parallel to the optical axis, the structures may be designed to operate with some tolerance in a divergence of incoming radiation. For example, an input beam of radiation that is parallel to the optical axis may exhibit a divergence angle of +/−10 degrees or +/−15 degrees from the optical axis.

The radiation source may include an array of Vertical Cavity Surface Emitting Lasers (VCSELs).

Advantageously, the combination of the optical element and the array of VCSELs may be configured as an infrared proximity sensor, such as a direct or indirect time-of-flight sensor,

According to a second aspect of the disclosure, there is provided a method of wafer-level manufacturing of the optical element according to the first aspect.

The method may include a step of forming a plurality of structures on a substrate by a process of molding, nano-imprinting, or photolithography. In a cross-section orthogonal to the substrate, an upper portion of a surface of each structure may include a greater tilt-angle relative to an optical axis orthogonal to the substrate than a lower portion of the surface, the lower portion being closer to the substrate than the upper portion.

Each structure may be formed on the substrate such that radiation entering each structure through the substrate, in a direction substantially parallel to the optical axis and undergoing internal reflection within each structure exits the surface of each structure along a path that does not intersect a directly adjacent structure of the plurality of structures.

Advantageously, established commercial manufacturing techniques, such as molding, nano-imprinting, or photolithography, may be adapted to manufacture optical elements according to the first aspect, thereby providing efficient and/or low cost manufacturing solutions.

The above summary is intended to be merely exemplary and non-limiting. The disclosure includes one or more corresponding aspects, embodiments or features in isolation or in various combinations whether or not specifically stated in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF THE DRAWINGS

These and other aspects of the present disclosure will now be described, by way of example only, with reference to the accompanying drawings, wherein:

FIG. 1 depicts a cross-sectional view of a prior art optical prism;

FIG. 2 depicts a cross-sectional view of a further prior art optical prism;

FIG. 3 depicts a cross-sectional view an arrangement of prisms;

FIG. 4 depicts a cross-sectional view a further arrangement of prisms;

FIG. 5 depicts a cross-sectional view of a structure for an optical element according to an embodiment of the disclosure;

FIG. 6 depicts a partial cross-sectional view of a model of a simulated optical element, according to an embodiment of the disclosure;

FIG. 7 depicts a perspective view of the simulated optical element of FIG. 6 and a representation of a resultant radiation profile;

FIG. 8 depicts plan and perspective views of a structure for an optical element according to a further embodiment of the disclosure;

FIG. 9 depicts cross-sectional views of the structure of FIG. 8;

FIG. 10 depicts a representation of a resultant radiation profile from the structure of FIGS. 8 and 9;

FIG. 11 depicts plan and perspective views of an optical element according to an embodiment of the disclosure;

FIG. 12 depicts plan views of a method of forming an optical element according to an embodiment of the disclosure; and

FIG. 13 depicts a plan view of an optical element according to a further embodiment of the disclosure, and cross-sectional view of an optical module including the optical element.

### DETAILED DESCRIPTION

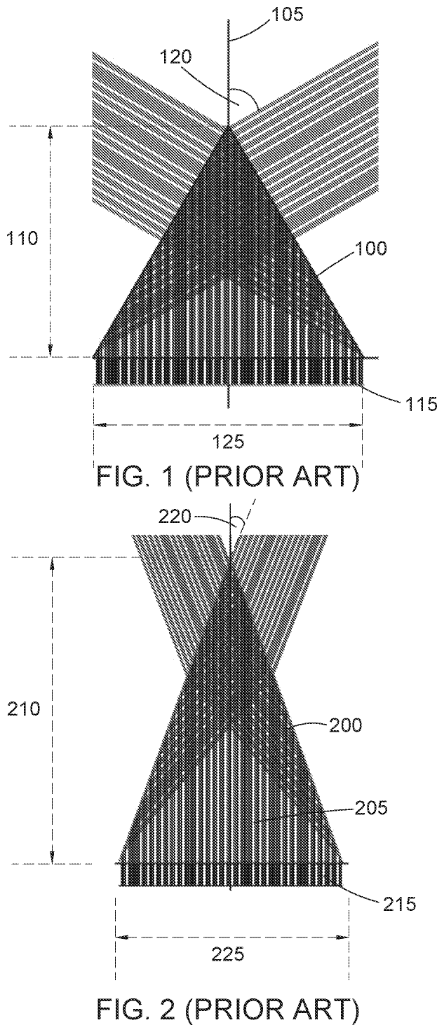

General operation of optical prisms and shortcomings of the prior art are descried with reference to FIGS. 1 to 4.

FIG. 1 depicts a cross-sectional view of a prior art first optical prism 100. Radiation 115 enters a base of the first optical prism 100 in a direction parallel to an optical axis 105. The radiation 115 is internally reflected off an internal surface of the first optical prism 100 by means of Total Internal Reflection (TIR) to exit an opposing surface of the first optical prism 100. The radiation 115 exits the first optical prism 100 along a path at a first angle 120 relative to the optical axis 105.

For purposes of example only, the first optical prism 100 has a base of first width 125 and a first height 110, which is a maximum height of the first optical prism 100. The angle first 120 depends, at least in part, upon an angle of the internal surface relative to the optical axis 105.

FIG. 2 depicts a cross-sectional view of a prior art second optical prism 200. For purposes of example only, the second optical prism 200 has a base of second width 225 and a second height 210. The second width 225 is substantially the same as the first width 125. The second height 210 is greater than the first height 110. Radiation 215 enters the base of the second optical prism 200 in a direction parallel to an optical axis 205, and is internally reflected off an internal surface of the second optical prism 200 by means of TIR to exit an opposing surface of the second optical prism 200. Due to the steeper internal surfaces of the second optical prism 200 relative to the internal surfaces of the first optical prism 100, the radiation 215 exits the second optical prism 200 along a path at a second angle 220 relative to the optical axis 205, wherein the second angle 220 is smaller than the first angle 120.

Thus, as is well known in the art, it can be seen that by increasing a steepness of the above-described internal surfaces of an optical prism relative to the optical axis 105, 205, an angle 120, 220 at which radiation 115, 215 exits the surface by means of TIR within the prisms may be increased.

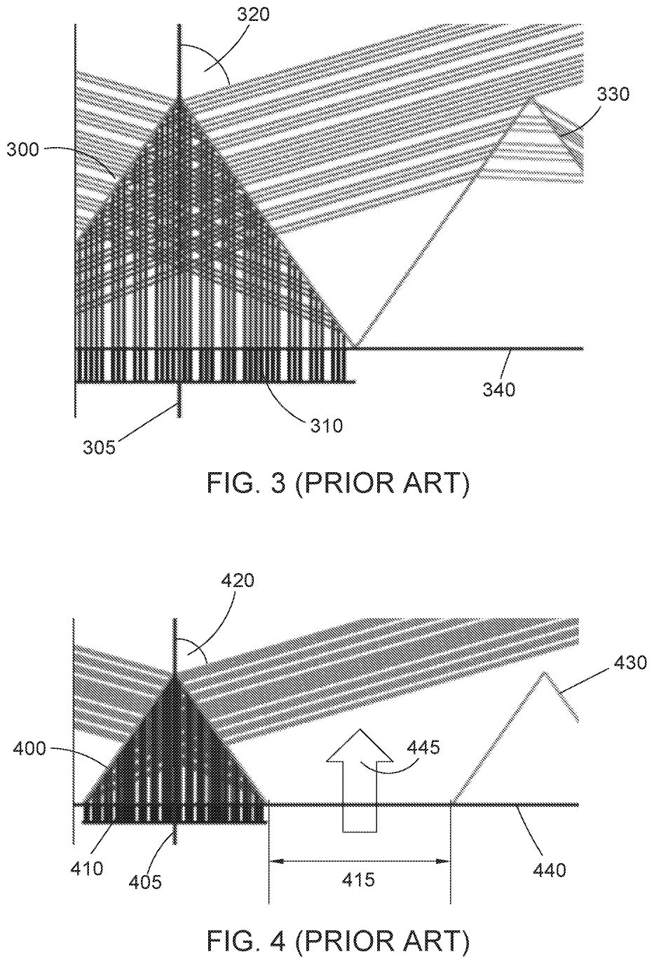

FIG. 3 depicts a cross-sectional view an arrangement including a third optical prism 300 and a fourth optical prism 330 formed on a substrate 340.

Third optical prism 300 is immediately adjacent the fourth optical prism 330. That is, a base of the third optical prism 300 meets a base of the fourth optical prism 330.

Radiation 310 enters the third optical prism 300 and, as described above with reference to FIGS. 1 and 2, is internally reflected within the third optical prism 300 by means of TIR, thereby exiting the third optical prism 300 at a third angle 320 relative to an optical axis 305.

It can be seen that the radiation 310 exits the third optical prism 300 along a path that partially intersects the directly adjacent fourth optical prism 330. A portion of the radiation is then refracted by the fourth optical prism 330 and a path of the portion of the radiation 310 deviates from an initial path of the radiation 310 as it exits the third optical prism 300.

As such, for an optical element including such immediately adjacent prisms 300, 330 formed on a substrate 340 and designed to emit radiation at the third angle 320, some optical losses may be incurred due to the above-described “shadowing” effect, wherein radiation from the third optical prism 300 is partially blocked by the neighboring fourth optical prism 330.

As can be seen by comparing FIGS. 1 and 2, by increasing a steepness of the internal surfaces of the optical prisms 300, 330 relative to the optical axis 305, the angle at which radiation exits the optical prism may be decreased to avoid interaction with an adjacent optical prism. However, this may reduce a total field of illumination that such an optical element may provide, due to a resultant decrease in the angle.

In the example of FIG. 4, a fifth optical prism 400 and a sixth optical prism 430 are formed on a substrate 440. The fifth optical prism 400 and a sixth optical prism 430 generally correspond to the third optical prism 300 and fourth optical prism 330, but spaced apart by a gap 415.

As such, radiation 410 entering a base of the fifth optical prism 400 parallel to an optical axis 405 and undergoing TIR within the fifth optical prism 400, exits the fifth optical prism 400 at an angle 420 relative to the optical axis 405 but does not intersect the adjacent sixth optical prism 430.

However, radiation 445 propagating through the substrate 440 at the gap 415 between the fifth optical prism 400 and the sixth optical prism 430 is not refracted by any optical prism 400, 430. Therefore, such radiation 445 continues along a path parallel to the optical axis 405.

Thus, from reviewing FIGS. 1 to 4, it can be seen that to form an optical element capable of refracting radiation to provide a relatively wide field of illumination, adjacent prisms formed on a substrate may provide a relatively poor optical efficiency. This is because radiation exiting a prism may intersect an adjacent prism, as shown in FIG. 3. If the prisms are spaced apart as depicted in FIG. 4 to address this problem, then optical efficiency may be affected due to radiation propagating through gaps between the prisms.

If the prisms are designed to be taller to avoid intersection of the radiation between adjacent prisms, as seen by comparing FIGS. 1 and 2, then an overall field of illumination may be reduced. Furthermore, excessively tall prisms may provide manufacturing challenges.

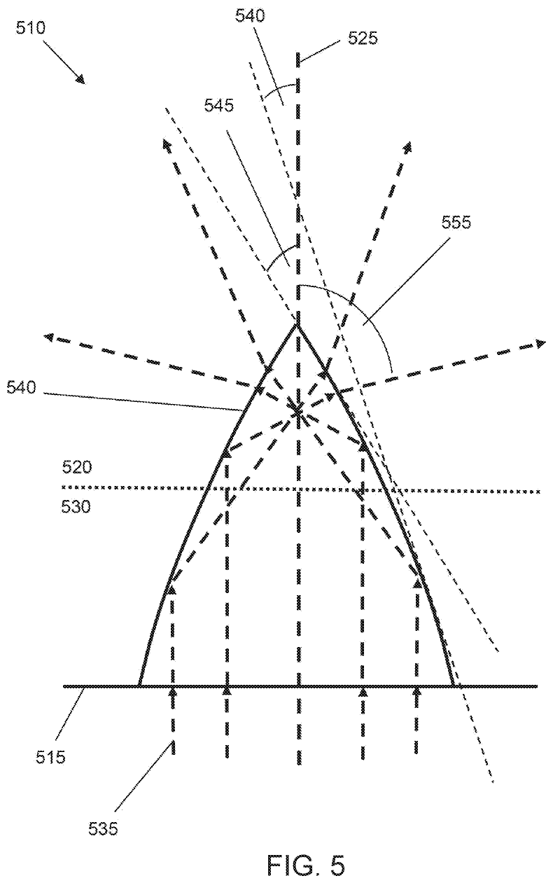

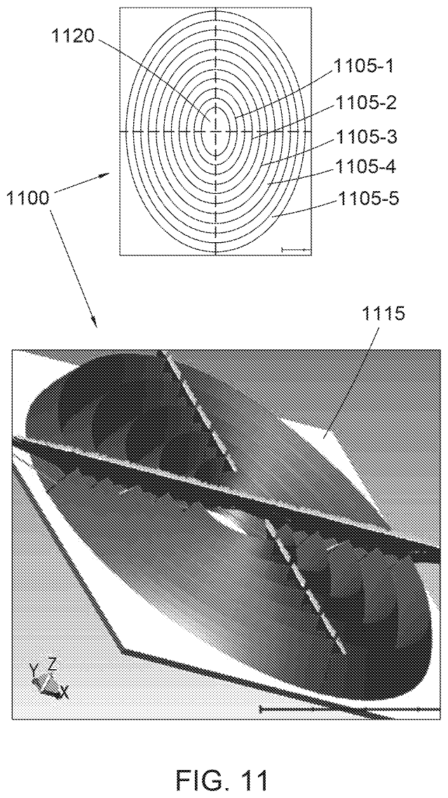

FIG. 5 depicts a cross-sectional view of a structure 505 for an optical element according to an embodiment of the disclosure. Although only a single structure 505 is depicted in FIG. 5, an optical element according to embodiments of the disclosure may include a plurality of such structures 505, as described in further detail below, in particular with reference to FIG. 11.

The cross-sectional view of FIG. 5 is orthogonal to a plane defined by a substrate 515.

The structure 505 is formed on the substrate 515. The structure 505 may, for example, be formed by a process of molding, nano-imprinting, or photolithography.

In an embodiment, in a cross-section the structure 505 has a substantially curve-sided triangular shape. That is, the structure 505 has a flat base defined by the planar substrate 515, and two sides that meet at a peak, wherein the sides have slight curvatures as described below.

Although the example structures described herein with reference to the drawings generally include two sides that meet at a point, e.g. the peak, in some embodiments of the disclosure the structure 505 may include two sides that meet at a rounded peak, e.g. a generally curved peak rather than at a point.

An upper portion 520 of a surface 550 of the structure 505 includes a greater tilt-angle relative to an optical axis 525 orthogonal to the substrate than a lower portion 530 of the surface 550, wherein the lower portion 530 is closer to the substrate 515 than the upper portion 520.

That is, the upper portion 520 of the surface 550 of the structure 505 includes a first tilt-angle 545 relative to an optical axis 525, and the lower portion 530 of the surface of the structure 505 includes a second tilt-angle 540 relative to the optical axis 525, wherein the first tilt angle 545 is greater than the second tilt angle 540.

For purposes of example only, in the example of FIG. 5 a distinct upper portion 520 and a lower portion 530 are denoted. It will, however, be understood that due to a curvature of the surfaces 550, e.g. the sides of the structure 505 in the embodiment of FIG. 5, an upper portion is any portion of the surface 550 that is generally further from the substrate 515 than any corresponding lower portion.

Also depicted in FIG. 5 is radiation 535 entering the structure 505 through the substrate 515 in a direction substantially parallel to the optical axis 525.

Due to the relatively steep sides of the structure 505 close to the base of the structure 505, e.g. in the lower portion of the structure 530, radiation 535 incident upon an internal surface of a side of the structure 505 is reflected by total internal reflection. Said radiation 535 then exits an opposing side of the structure 505 relatively close to a peak of the structure 505, e.g. the upper portion 520 of the structure 505.

The radiation 535 does not exit the lower portion 530 of the structure 505. As such, the structure 505 may be suitable for implementing immediately adjacent a further structure (not shown in FIG. 5), without the radiation 535 being incident upon the further structure.

Furthermore, radiation 535 exiting the structure 505 relatively close to a peak of the structure 505, e.g. within the upper portion 520, may follow a path at a relatively large angle 555 to the optical axis 525. As such, the structure 505 is suitable for use in an optical element providing a relatively large field of illumination.

Although the cross-section of the structure 505 is depicted in FIG. 5 as being symmetrical about the optical axis 525, in other embodiments falling within the scope of the disclosure the structure 505 may not be symmetrical about the optical axis 525.

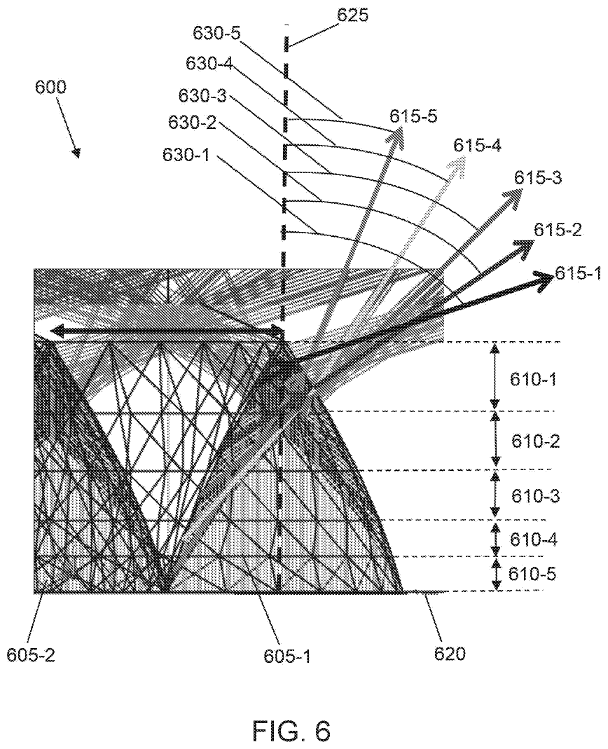

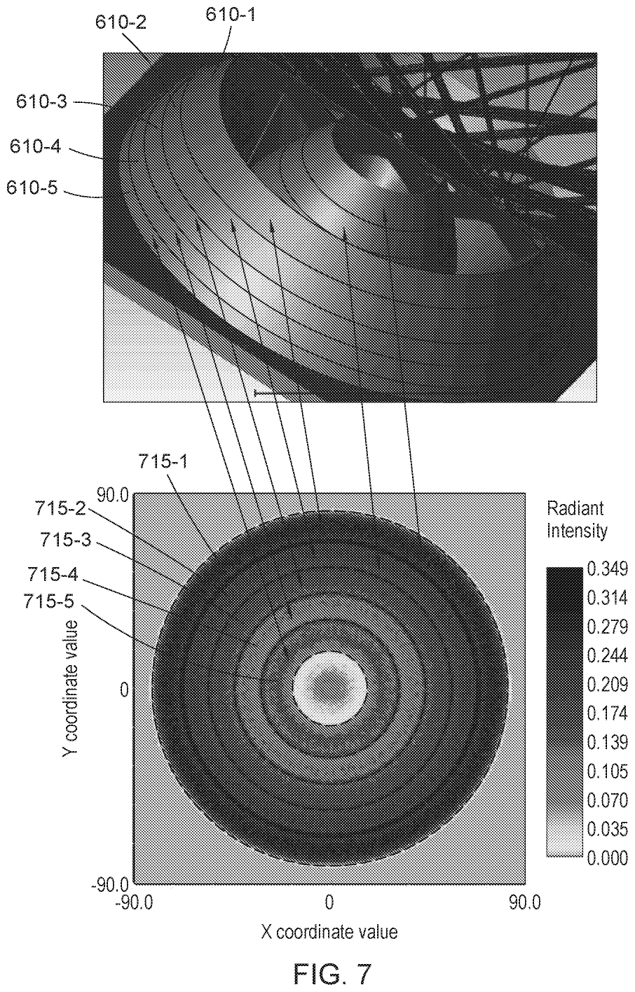

FIG. 6 depicts a partial cross-sectional view of a model of a simulated optical element 600. FIG. 7 depicts a perspective view of the simulated optical element, together with a representation of a simulated radiation profile.

The simulated optical element 600 includes a first structure 605-1 and a second structure 605-2. Although only two structures 605-1, 605-2 are depicted, it will be appreciated that substantially more than two structures may be implemented in an optical element, as described in more detail below, in particular with reference to FIG. 11.

Each structure 605-1, 605-2 is formed as a closed-loop shape, e.g. a ring shape, as is evident from the perspective view in FIG. 7. That is, in the example embodiment each structure 605-1, 605-2 is rotationally symmetrical about an axis parallel to an optical axis 625 orthogonal to the substrate 620. In other embodiments falling within the scope of the disclosure, the structures 605-1, 605-2 may be formed as ellipses, ovals, rings, or any other continuous free-form shape in a cross-section parallel to the plane.

The first structure 605-1 and the second structure 605-2 are concentrically arranged on a substrate 620.

In the example of FIGS. 6 and 7, each side of each structure 605-1, 605-2 is formed from five distinct segments: a first segment 610-1; a second segment 610-2; a third segment 610-3; a fourth segment 610-4; and a fifth segment 610-5. As such, each structure 605-1, 605-2 is a prism.

The first segment 610-1 is at a greater tilt-angle relative to the optical axis 625 orthogonal to the substrate 620 than the second segment 610-2. The second segment 610-2 is at a greater tilt-angle relative to the optical axis 625 than the third segment 610-3. The third segment 610-3 is at a greater tilt-angle relative to the optical axis 625 than the fourth segment 610-4. The fourth segment 610-4 is at a greater tilt-angle relative to the optical axis 625 than the fifth segment 610-5.

Radiation enters each structure 605-1, 605-2 through a base, e.g. through the substrate 620, in a direction substantially parallel to the optical axis 625.

The ensuing description refers predominantly to operation of the first structure 605-1. It will be appreciated that the description also applies to the second structure 605-2. Furthermore, for simplicity of illustration, only radiation incident upon an internal surface of a first side of the first structure 605-1 is described. It will be appreciated that the same mode of operation applies to radiation incident upon an internal surface of a second side of each of the first structure 605-1 and the second structure 605-2.

A first portion of the radiation is incident upon an internal surface of the first segment 610-1 of the first structure 605-1. The first portion of the radiation is reflected by total internal reflection towards an opposite surface of the first structure 605-1, and exits the first structure 605-1 substantially in a first direction 615-1. The first direction 615-1 is at a first angle 630-1 to the optical axis 625.

As shown in the simulated radiation profile of FIG. 7, the radiation substantially in the first direction 615-1 contributes to a first ring 715-1 of radiation.

A second portion of the radiation is incident upon an internal surface of the second segment 610-2 of the first structure 605-1. The second portion of the radiation is reflected by total internal reflection towards an opposite surface of the first structure 605-1, and exits the first structure 605-1 substantially in a second direction 615-2. The second direction 615-2 is at a second angle 630-2 to the optical axis 625. The second angle 630-2 is smaller than the first angle 630-1. As shown in the simulated radiation profile of FIG. 7, the radiation substantially in the second direction 615-2 contributes to a second ring 715-2 of radiation.

A third portion of the radiation is incident upon an internal surface of the third segment 610-3 of the first structure 605-1. The third portion of the radiation is reflected by total internal reflection towards an opposite surface of the first structure 605-1, and exits the first structure 605-1 substantially in a third direction 615-3. The third direction 615-3 is at a third angle 630-3 to the optical axis 625. The third angle 630-3 is smaller than the second angle 630-2. As shown in the simulated radiation profile of FIG. 7, the radiation substantially in the third direction 615-3 contributes to a third ring 715-3 of radiation.

A fourth portion of the radiation is incident upon an internal surface of the fourth segment 610-4 of the first structure 605-1. The fourth portion of the radiation is reflected by total internal reflection towards an opposite surface of the first structure 605-1, and exits the first structure 605-1 substantially in a fourth direction 615-4. The fourth direction 615-4 is at a fourth angle 630-4 to the optical axis 625. The fourth angle 630-4 is smaller than the third angle 630-3. As shown in the simulated radiation profile of FIG. 7, the radiation substantially in the fourth direction 615-4 contributes to a fourth ring 715-4 of radiation.

Finally, a fifth portion of the radiation is incident upon an internal surface of the fifth segment 610-5 of the first structure 605-1. The fifth portion of the radiation is reflected by total internal reflection towards an opposite surface of the first structure 605-1, and exits the first structure 605-1 substantially in a fifth direction 615-5. The fifth direction 615-5 is at a fifth angle 630-5 to the optical axis 625. The fifth angle 630-5 is smaller than the fourth angle 630-4. As shown in the simulated radiation profile of FIG. 7, the radiation substantially in the fifth direction 615-5 contributes to a fifth ring 715-5 of radiation.

That is, radiation exits the first structure 605-1 along paths defined by the first angle 630-1, second angle 630-2, third angle 630-3, fourth angle 630-4 and fifth angle 630-5. In some embodiments one or more of such angles may be 70 degrees, or even greater.

As indicated in FIG. 7, a first segment of the second structure 605-2 also contributes to the first ring 715-1 of radiation. Similarly, a second segment of the second structure 605-2 also contributes to the second ring 715-2 of radiation, and so on.

That is, in embodiments each structure 605-1, 605-2 having a substantially same cross-section contributes to substantially the same radiation profile.

Notably, radiation exiting the first structure 605-1 and the second structure 605-2 does not intersect the second structure 605-2 and the first structure 605-1 respectively.

It will be appreciated that although structures including only five segments 610-1, 610-2, 610-3, 610-4, 610-5 are described, in other embodiments fewer than or more than five segments may be implemented.

Furthermore, in embodiments of the disclosure, the structures are not segmented and are instead ‘freeform’ structures having smooth curved sides. As such, although five distinct rings of radiation 715-1, 715-2, 715-3, 715-4, 715-5 are depicted in FIG. 7, a non-segmented embodiment of the disclosure would produce a resultant radiation profile as a continuum without distinct rings.

Although the cross-sections of the first structure 605-1 and the second structure 605-2 are depicted in FIG. 6 as being symmetrical about the optical axis 625, in other embodiments falling within the scope of the disclosure the structures 605-1, 605-2 may not be symmetrical about the optical axis 625.

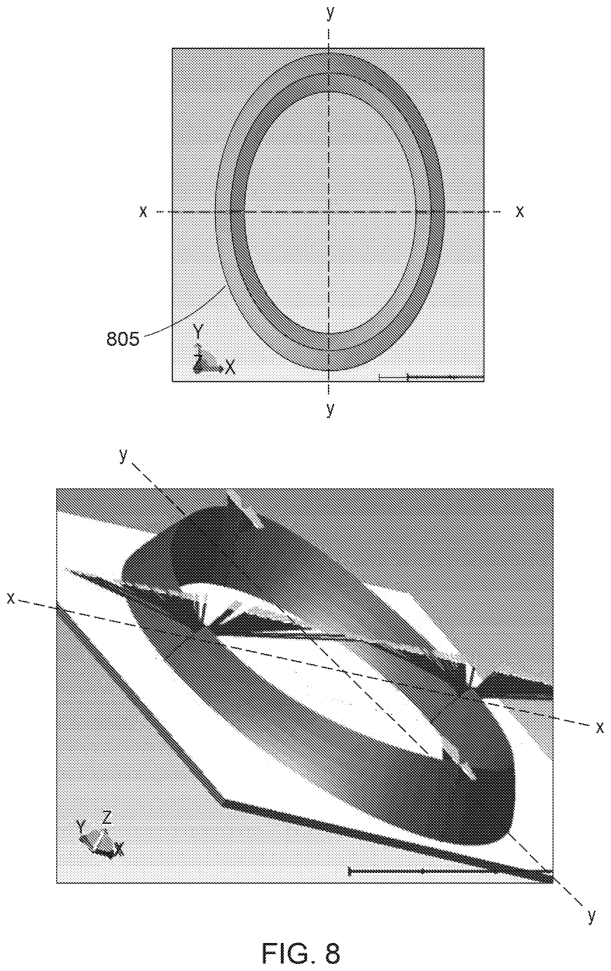

A particular radiation profile may be tuned by selecting dimensions of a structure, as will be described with reference to FIGS. 8 to 10.

For example, in contrast to the circular structures 605-1, 605-2 of FIG. 7, the structure 805 of FIG. 8 is non-circular, e.g. has a non-circular footprint on a substrate. The structure 805 is substantially oval-shaped in a plane parallel to a substrate, and therefore is not rotationally symmetrical about an axis.

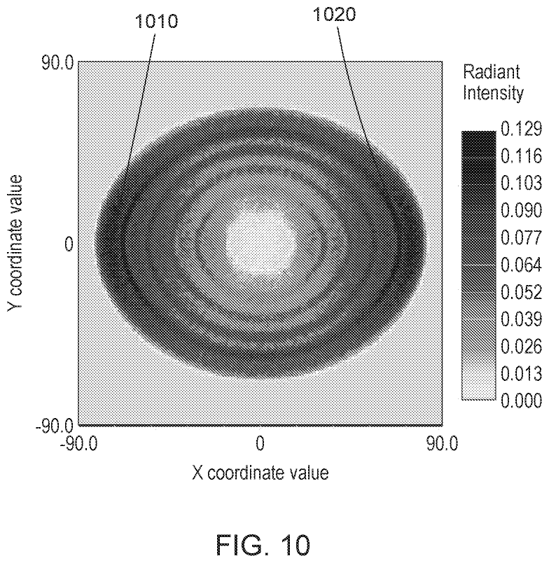

The non-circular shape of the structure 805 affects a resultant radiation profile, as can be seen by comparing the radiation profile in FIG. 10 to the radiation profile in FIG. 7.

The non-circular footprint results in first intensity peak 1010 and second intensity peak 1020, rather than the relatively uniform intensity distributions of the structures 605-1, 605-2 having circular footprints.

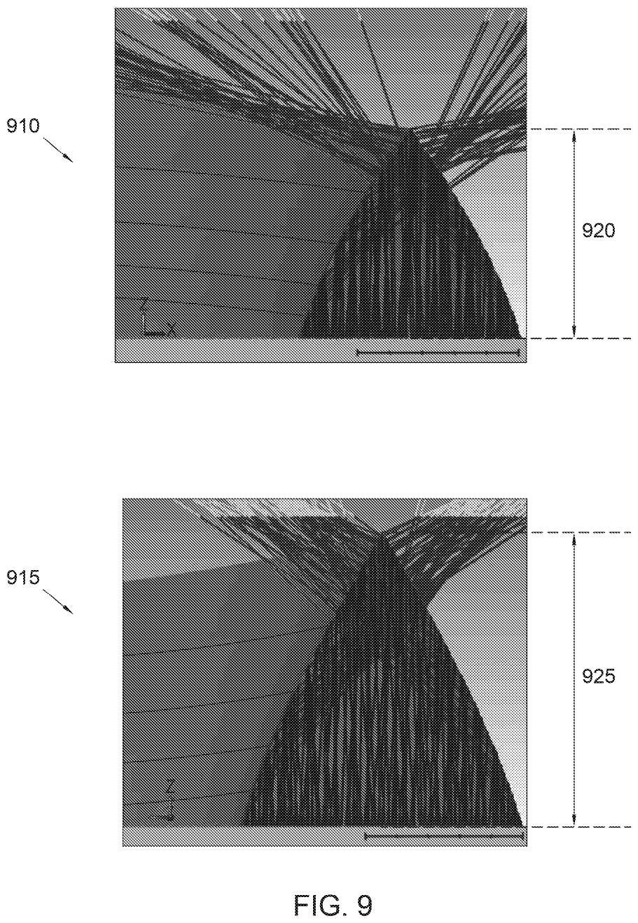

Furthermore, a height of the structure 805 varies along a portion of the one or more structures. For example, FIG. 9 depicts a first cross-section 910 of the structure 805 taken across an axis denoted X-X in FIG. 8.

FIG. 9 also depicts a second cross-section 915 taken across an axis denoted Y-Y in FIG. 8.

In the first cross-section 910, a first height 920 of the structure 805 is relatively low. In the second cross-section 915, a second height 925 of the structure 805 is relatively high. As can be seen in FIG. 9, such variations in the height of the structure 805 affect tilt angles of the sides of the structure 805, and thereby angles at which radiation exits the structure 805.

Such a variation in height around a length of the structure 805 may affect a shape of the intensity distribution. For example, as shown in FIG. 10, it can be seen that the intensity distribution extends further in a X-X direction, e.g. between approximately −80 and +80 units, than it does in the y-y direction, e.g. between approximately −70 and +70 units.

As such, by adapting the dimension of the structure 805, beam-shaping may be effectively performed. That is, by selecting appropriate height, base-width, and shape of one or more structures, e.g. structure 805, a beam having a desired shape and intensity profile may be provided.

FIG. 11 depicts plan and perspective views of an optical element 1100 according to an embodiment of the disclosure. In the example embodiment of FIG. 11, a plurality of structures 1105-1, 1105-2, 1105-3, 1105-4, 1105-5 are formed on a substrate 1115.

The structures 1105-1, 1105-2, 1105-3, 1105-4, 1105-5 each have a cross-section generally as depicted in FIG. 5 or 6, e.g, wherein an upper portion of a surface of each structure 1105-1, 1105-2, 1105-3, 1105-4, 1105-5 includes a greater tilt-angle relative to an optical axis orthogonal to the substrate 1115 than a lower portion of the surface, the lower portion being closer to the substrate 1115 than the upper portion.

In the example of FIG. 11, the plurality of structures 1105-1, 1105-2, 1105-3, 1105-4, 1105-5 are arranged concentrically on the substrate 1115. That is, each structure is immediately adjacent a neighboring structure, such that there are no gaps between the structures 1105-1, 1105-2, 1105-3, 1105-4, 1105-5.

For simplicity of illustration, a center 1120 of the optical element 1100 is depicted as empty. In some embodiments of the disclosure, a lens may be disposed at the center of the concentrically arranged plurality of structures 1105-1, 1105-2, 1105-3, 1105-4, 1105-5. In some embodiments of the disclosure, a microlens array may be disposed at the center. In yet further embodiments, a substantially conical structure may be disposed at a center. In such embodiments, the substantially conical structure may have a cross-section in a plane orthogonal to the substrate 1115 that is substantially the same as a cross-section of one or more of the concentrically arranged structures 1105-1, 1105-2, 1105-3, 1105-4, 1105-5.

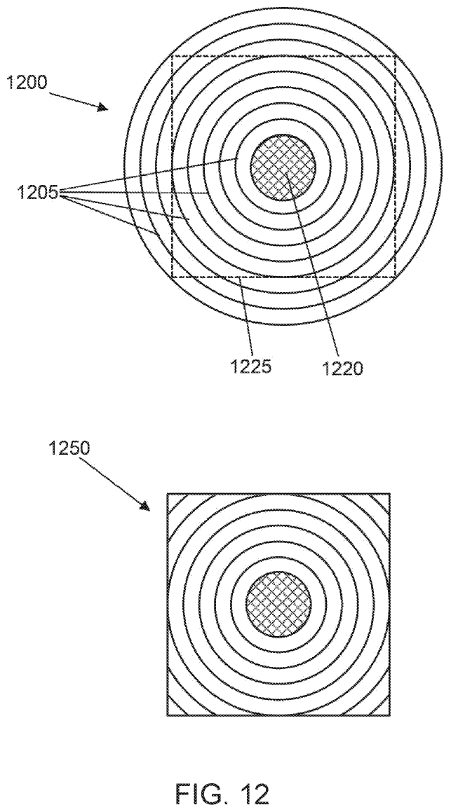

FIG. 12 depicts plan views of a method of forming an optical element 1200 according to an embodiment of the disclosure. The optical element 1200 includes a plurality of concentrically arranged structures 1205. The concentrically arranged structures 1205 each have a cross-section generally as depicted in FIG. 5 or 6.

Also, a microlens array 1220 is formed in a center of the optical element 1200. In some embodiments, the microlens array 1220 may be configured to fill an area inside the concentric arrangement of structures 1205, such that radiation propagating though the through the center of the concentrically arranged plurality of structures 1205 also propagates through the microlens array 1220. Advantageously, in some embodiments, the microlens 1220 array may be configured to redirect the radiation to provide field of illumination that is continuous with a field of illumination provided by the plurality of structures 1205.

It may be desirable for the optical element 1200 to have a substantially square or rectangular, or otherwise regular shape 1225. That is, it may be desirable that the optical element 1200 has a shape that does not conform to a shape of the structures 1205.

In one example, the structures 1205 are formed on a substrate by a process of wafer-level manufacturing, which may for example involve any of molding, nanoimprinting, or photolithography. The substrate and structures 1205 may subsequently be cut, e.g. diced, to form an optical element 1250 having the desired regular shape. As such, not all of the structures 1205 form complete closed loop shapes in the diced optical element 1250.

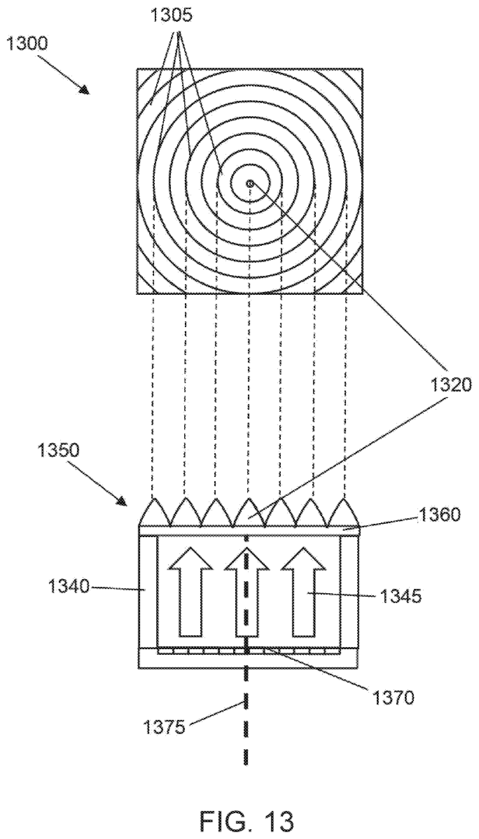

FIG. 13 depicts a plan view of an optical element 1300 according to a further embodiment of the disclosure. FIG. 13 also depicts a corresponding cross-sectional view of an optical module 1350 including the optical element 1300.

The optical element 1300 generally corresponds to the optical element 1200 of FIG. 11 except, instead of a microlens array 1220 in the center, a substantially conical structure 1320 is disposed at the center for purposes of example. A cross-section of the conical structure 1320 generally corresponds to a cross-section of each of the concentrically arranged structures 1305. Advantageously, the conical structure 1320 may enable substantially all of an optical surface of a substrate 1360 to be covered with structures having a similar cross-section, such that all structures 1305 including the central conical structure 1320 may contribute to a substantially same field of illumination.

Also shown in FIG. 13 is the optical module 1350 including the optical element 1300. The optical module 1350 includes a radiation source 1370. In some embodiments, the radiation source 1370 is an array of Vertical Cavity Surface Emitting Lasers (VCSELs).

A spacer 1340 separates the radiation source 1370 from the optical element 1300. In other embodiments, the radiation source 1370 may be immediately adjacent the optical element 1300. In some embodiments, the optical element 1300 may be formed on the radiation source 1370.

The radiation source 1370 is configured to emit radiation 1345 towards the substrate 1360 such that the radiation 1345 enters each structure 1305 through the substrate 1360 in a direction substantially parallel to an optical axis 1375.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### REFERENCE NUMERALS

100 first optical prism
105 optical axis
110 first height
115 radiation
120 first angle
125 first width
200 second optical prism
205 optical axis
210 second height
215 radiation
220 second angle
225 second width
300 third optical prism
305 optical axis
310 radiation
320 third angle
340 substrate
400 fifth optical prism
405 optical axis
410 radiation
415 gap
420 angle
430 sixth optical prism
440 substrate
445 radiation
505 structure
515 substrate
520 upper portion
525 optical axis
530 lower portion
535 radiation
540 second tilt-angle
545 first tilt angle
550 surface
555 angle
600 optical element
605-1 first structure
605-2 second structure
610-1 first segment
610-2 second segment
610-3 third segment
610-4 fourth segment
610-5 fifth segment
615-1 first direction
615-2 second direction
615-3 third direction
615-4 fourth direction
615-5 fifth direction
620 substrate
625 optical axis
630-1 first angle
630-2 second angle
630-3 third angle
630-4 fourth angle
630-5 fifth angle
715-1 first ring
715-2 second ring
715-3 third ring
715-4 fourth ring
715-5 fifth ring
805 structure
910 first cross-section
915 second cross-section
920 first height
925 second height
1010 first intensity peak
1015 second intensity peak
1100 optical element
1105-1 structure
1105-2 structure
1105-3 structure
1105-4 structure
1105-5 structure
1115 substrate
1120 center
1200 optical element
1205 structures
1220 microlens array
1225 regular shape
1250 optical element
1300 optical element
1305 structures
1320 conical structure
1340 spacer
1345 radiation
1350 optical module
1360 substrate
1370 radiation source
1375 optical axis

1. An optical element comprising a plurality of structures formed on a substrate, wherein:
in a cross-section orthogonal to a plane defined by the substrate, an upper portion of a surface of each structure comprises a greater tilt-angle relative to an optical axis orthogonal to the substrate than a lower portion of the surface, the lower portion being closer to the substrate than the upper portion; and
each structure is arranged on the substrate such that radiation entering each structure through the substrate, in a direction substantially parallel to the optical axis and undergoing internal reflection within each structure, exits the surface of each structure along a path that does not intersect a directly adjacent structure of the plurality of structures.

2. The optical element of claim 1, wherein the plurality of structures comprises one or more structures formed as a closed loop, ellipse, oval, ring, or continuous free-form shape in a cross-section parallel to the plane.

3. The optical element of claim 2, wherein a height of the one or more structures and/or a width of a base of the one or more structures varies along at least a portion of the one or more structures.

4. The optical element of claim 1, wherein each structure of the plurality of structures is disposed beside another structure of the plurality of structures such that there are no gaps between the structures.

5. The optical element of claim 1, wherein a height of each structure of the plurality of structures is substantially the same as a height of an adjacent structure of the plurality of structures.

6. The optical element of claim 1, wherein at least one structure of the plurality of structures is rotationally symmetrical about an axis parallel to the optical axis.

7. The optical element of claim 1, wherein the plurality of structures are arranged concentrically on the substrate.

8. The optical element of claim 7, comprising a microlens array disposed at a center of the concentrically arranged plurality of structures.

9. The optical element of claim 7, comprising a substantially conical structure disposed at a center of the concentrically arranged plurality of structures.

10. The optical element of claim 1, wherein a peak of one or more structures of the plurality of structures is rounded.

11. The optical element of claim 1, wherein the surface of each structure is segmented, wherein one or more segments in the upper portion has a tilt-angle greater than one or more segments in the lower portion.

12. The optical element of claim 1, wherein each structure is configured as a prism comprising a plurality of surfaces for reflecting and refracting the radiation entering each structure through the substrate.

13. The optical element of claim 1, wherein the path is at an angle of greater than 70 degrees relative to the optical axis.

14. An optical module comprising the optical element of claim 1 in combination with a radiation source, wherein the radiation source is configured to emit radiation towards the substrate such that the radiation enters each structure through the substrate in a direction substantially parallel to the optical axis.

15. The optical module of claim 14, wherein the radiation source comprises an array of Vertical Cavity Surface Emitting Lasers (VCSELs).

16. The optical module of claim 14, wherein the directly adjacent structure is a nearest neighboring structure.
